(19) United States
(12) Patent Application Publication
(10) Pub. No.: US 2011/0288319 A1
(43) Pub. Date: Nov. 24, 2011

(54) FILTER FOR DEEP FRYER

(75) Inventors: Terence Profughi, Chardon, OH (US); Gregory Paul Hercik, Twinsburg, OH (US)

(73) Assignee: TLP INVESTMENTS LLC, Chardon, OH (US)

(21) Appl. No.: 13/111,996

(22) Filed: May 20, 2011

Related U.S. Application Data
(60) Provisional application No. 61/346,622, filed on May 20, 2010.

(51) Int. Cl. B01D 35/28; C11B 3/16

(52) U.S. Cl. 554/175; 210/167.28

(57) ABSTRACT

Disclosed is a filter suitable for use with a deep fryer for filtering foreign particulates, such as solid particles, from cooking oil or shortening to minimize the carbonation of such particles and extend the useful life of the cooking oil. In particular, the filter does not use disposable paper filtration media.

This application claims priority to U.S. Provisional Patent Application Ser. No. 61/346,622, filed May 20, 2010. The disclosure of this application is hereby fully incorporated by reference in its entirety.

### BACKGROUND

The present disclosure relates generally to deep fryers, and more particularly, to deep fryers that are used in conjunction with a cooking oil reclamation system and process, and filters suitable for such a system and process.

A deep fryer generally includes a cooking vessel, i.e. a fryer vat that contains a cooking liquid, typically cooking oil or shortening. The cooking substance is heated, and a basket of food product is placed into the fryer vat such that the food products will be immersed within and cooked by the heated cooking oil for a desired period of time.

During cooking, various particulate food matter, such as breading or pieces of skin, is loosened from the food product and remains in the cooking liquid. To extend the useful life of the cooking liquid, it is a common practice to periodically filter the particulate food matter out of the cooking liquid to minimize the carbonization of such food matter within the cooking liquid.

A typical fryer filtration system may include the use of a cheese cloth or paper filter medium that has a fine mesh. The filter medium is arranged to receive and filter the oil. The oil is directed through the filtration device, and the waste particles are entrapped onto the filter medium. After the filtration process is complete, the cheese cloth or paper filter medium is disposed of. Periodic removal of the filter medium requires some downtime during which the deep fryer cannot be used, and replacement of the filter medium increases operating costs.

### BRIEF DESCRIPTION

Disclosed herein are various filter assemblies, systems, apparatuses, and methods for filtering a cooking liquid, such as cooking oil or shortening. In particular, the use of disposable filter media is reduced or eliminated in the present disclosure.

Disclosed in embodiments is a filter assembly, comprising: a micropanel screen, a support frame, and a metal screen. The micropanel screen is used for filtering relatively small particles, and has an upper side and a lower side. The support frame is attached to the lower side of the micropanel screen. The metal screen is used for filtering relatively large particles, and is located on the upper side of the micropanel screen.

The metal screen can be a pleated double dutch twill woven wire mesh screen, or a basket weave screen.

The support frame is attached, such as by brazing, to the lower side of the micropanel screen. Nickel can be used for the brazing composition. The support frame may further comprise at least one handle.

In embodiments, the support frame is in a windowed frame configuration with four edges and a central opening. In other embodiments, the support frame is in a metal sheet configuration with cellular openings.

In some embodiments, the support frame comprises an upper face attached to the lower side of the micropanel screen and a bracket extending downwards on three sides from the upper face. An additional filter can be inserted into the bracket.

The micropanel screen has perforations that extend from the upper side and taper down to the lower side. The support frame openings generally have a larger diameter than the perforations in the micropanel screen.

The filter assembly does not include a disposable filter medium.

Also disclosed in embodiments is a filter assembly, comprising: a micropanel screen for filtering relatively small particles; and a support frame attached to a lower side of the micropanel screen.

The support frame is attached by brazing. The brazing can be performed using nickel.

Further disclosed is a process for filtering particles from a dirty cooking liquid, comprising: passing the dirty cooking liquid through a metal screen to remove relatively large particles from the dirty cooking liquid to obtain a strained cooking liquid; and passing the strained cooking liquid through a micropanel screen to remove relatively small particles from the strained cooking liquid to obtain a cleaned cooking liquid.

The process may further comprise returning the cleaned cooking liquid to a cooking vessel from which the dirty cooking liquid was obtained. In this manner, the useful lifetime of the cooking liquid can be extended.

Also disclosed is a filter assembly for filtering solid particles from a cooking liquid used in a deep fryer, comprising: a micropanel screen for filtering relatively small particles, the micropanel screen having an upper face and a lower face; a metal screen for filtering relatively large particles, the metal screen being located on the upper face of the micropanel screen; a support frame comprising an upper face, a bracket extending downwards on three sides from the upper face, and a central opening, wherein the upper face is attached to the lower face of the micropanel screen; and an additional filter inserted into the bracket of the support frame.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a perspective view of a deep fryer in which the filter assembly of the present disclosure can be used.

FIG. 2 is a schematic of a filtration system in which the filter assembly of the present disclosure can be used.

FIG. 3 is a schematic of another filtration system in which the filter assembly of the present disclosure can be used.

FIG. 4 is an exemplary embodiment of the filter assembly.

FIG. 5A is a top view of an exemplary embodiment of the microscreen panel of the present disclosure.

FIG. 5B is a side view of the microscreen panel of FIG. 5A.

FIG. 6A is a top view of a first exemplary embodiment of the support frame of the present disclosure.

FIG. 6B is a perspective view of the support frame of FIG. 6A.

FIG. 6C is a perspective view of another exemplary embodiment of the support frame, having a plurality of cellular openings.

FIG. 7 is a picture of a microscreen panel brazed to a support frame.

FIG. 8A is a perspective view of a woven wire mesh that can be used as the metal screen of the present disclosure.

FIG. 8B is a perspective view of a pleated woven wire mesh that can be used as the metal screen of the present disclosure.

FIG. 9A is side view of a basket weave screen that can be used as the metal screen of the present disclosure.

FIG. 9B is a perspective view of the basket weave screen of FIG. 9A.

FIG. 10A is a perspective view of a filter assembly with handles.

FIG. 10B is a perspective view of a cylindrical filter assembly.

FIG. 11 is a perspective view of another exemplary filter assembly of the present disclosure. Here, the support screen has brackets to hold an additional filter.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The present disclosure relates to filter assemblies suitable for use with deep fryers, and that are used to filter particulates from the cooking liquids used in such deep fryers.

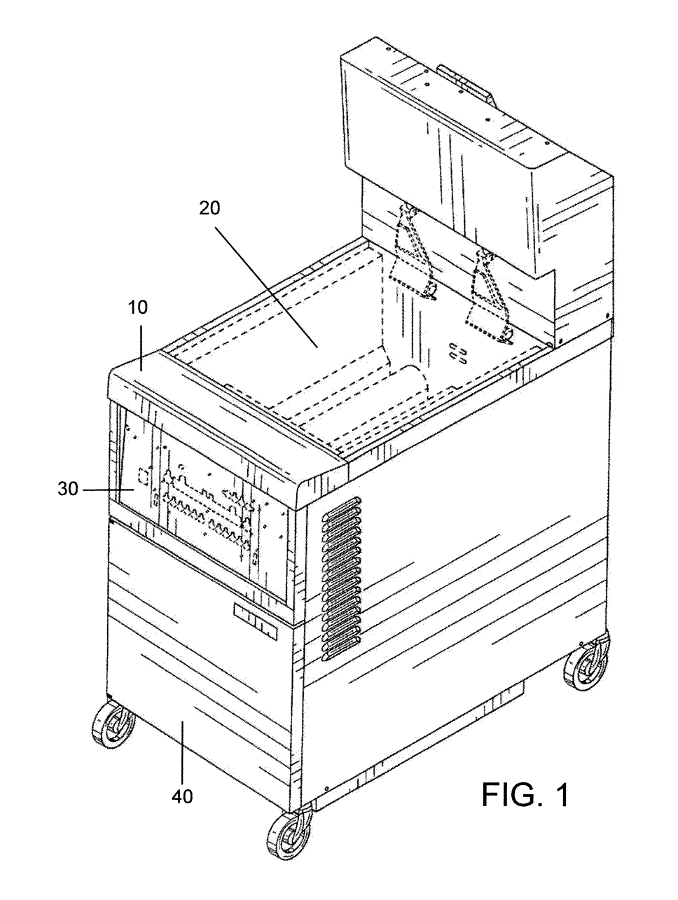

In this regard, FIG. 1 is a perspective view of an exemplary deep fryer. The deep fryer 10 contains a cooking vessel 20 into which a cooking liquid, such as cooking oil or shortening, is placed. Heating elements (not shown) heat the cooking liquid to a desired temperature, typically between 350 to about 400 degrees Fahrenheit (° F.). A controller 30 allows the user to control the cooking process. The cooking vessel shown here is sized to fry two different food baskets (not shown) simultaneously. On the front of the deep fryer is an access door 40, which permits access to the internal cavity of the deep fryer 10.

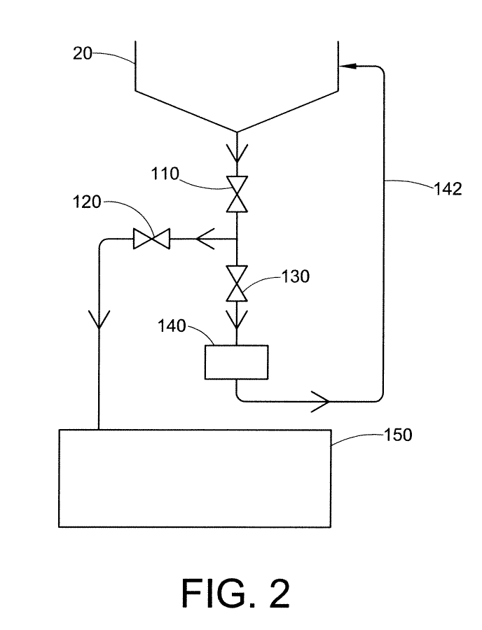

FIG. 2 provides a diagrammatic view of one exemplary arrangement of components of the filtration system used with the deep fryer. The bottom of the cooking vessel 20, i.e. a fryer vat, is seen here extending in the internal cavity and connects to drain valve 110. When it is desired to remove the cooking liquid from the cooking vessel, drain valve 110 is opened. If the cooking liquid is to be filtered, then valve 120 is closed and valve 130 is opened. The cooking liquid can then flow through filter 140 and returned to the cooking vessel 20 through oil return path 142. Alternatively, if it is desired to dispose of the cooking liquid, valve 120 is opened and valve 130 is closed. The cooking liquid can then be sent to disposal pan 150. Pumps (not shown) may be suitably arranged to cause the cooking liquid to flow as desired.

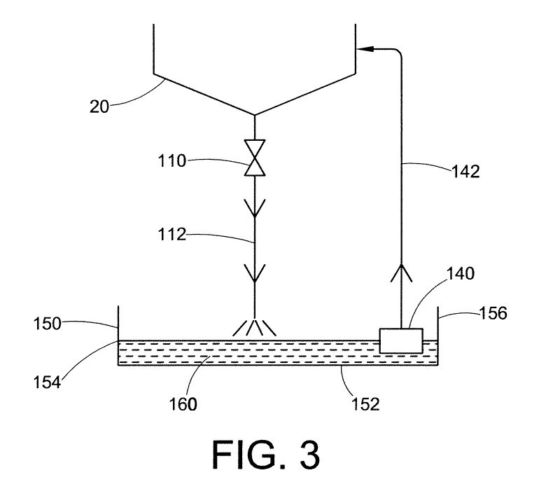

Alternatively, FIG. 3 is a diagrammatic view of another exemplary arrangement of components of the filtration system. Here, again drain valve 110 controls the flow of cooking liquid from the cooking vessel 20. The cooking liquid passes through drain line 112 and is emptied into disposal pan 150 (drained cooking liquid is labeled with reference numeral 160). The disposal pan 150 is shown here in cross-section with bottom wall 152 and side walls 154, 156. Initially, while the cooking liquid is still hot, gravity will cause particulates to settle on the bottom wall 152 of the disposal pan 150. The filter 140 lies near the bottom wall 152 of the disposal pan, or in other words is positioned with an open end at a location spaced above the bottom wall 152, (e.g., ½ inch to 2 inches). Hot cooking liquid is sucked upwards through the filter 140, which prevents particulates from being sucked upwards as well, so that the particulates remain in the disposal pan 150. The cooking liquid is then returned through oil return path 142 to the cooking vessel 20. Again, pumps (not shown) are arranged as needed.

The filtration system may also be a separate external unit that is connected to the deep fryer 10 when in use and disconnected from the fryer 10 when not in use.

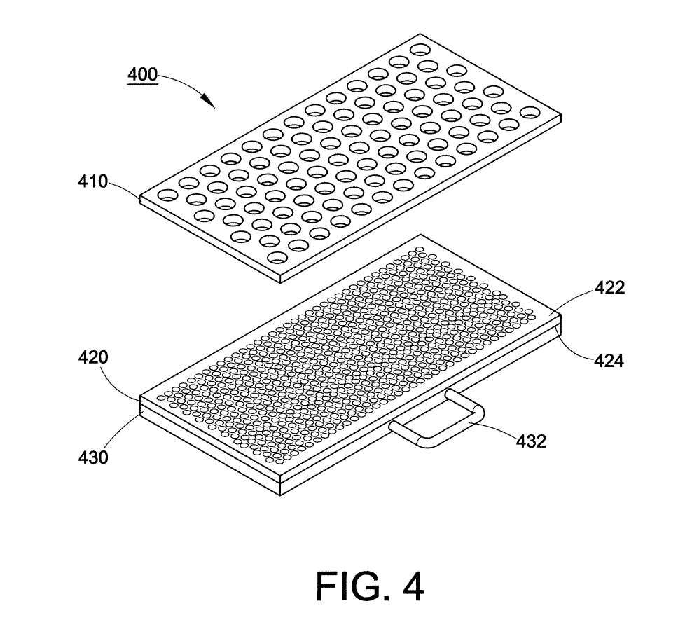

The filtration system contains a filter assembly. Referring to FIG. 4, the filter assembly 400 comprises a metal screen 410 and a micropanel screen 420. The metal screen 410 is used to capture relatively large particles, while the micropanel screen 420 is used to capture relatively small particles (the screens being compared to each other in terms of the particle sizes they capture). Each screen 410, 420 may be considered to contain openings that allow the cooking liquid to flow through the screen and leave the filtered particles behind on the screen.

The micropanel screen 420 has a first or upper side 422 or face, and a second or lower side 424 or face. The metal screen 410 is located on the upper side 422 of the micropanel screen. Attached to the lower side 424 of the micropanel screen is a support frame 430. The support frame provides structural support to the micropanel screen. At least one handle 432 may be provided on the support frame, for providing an easy means of manipulating the filter assembly 400. In particular embodiments, it is contemplated that two handles will be provided, on opposite sides of the support frame.

In particular embodiments, the support frame 430 and the micropanel screen 420 are brazed together. Brazing is a process for joining two close-fitting metal pieces together. A filler metal or alloy is heated to its melting temperature, and then distributed between the two pieces by capillary action. The filler metal interacts with a thin layer on the surface of each of the metal pieces, and is then cooled rapidly to form a seal between the two metal pieces. Of particular importance, the brazing here seals the support frame to the micropanel screen, and prevents debris, such as food particles, from being trapped between the support frame 430 and the micropanel screen 420. In embodiments, nickel is the filler metal used in a brazing composition to bond the support frame 430 and the micropanel screen 420 together. Other possible filler metals in the brazing composition include copper, silver, nickel, and gold. Alloys containing these metals can also be used as filler metals.

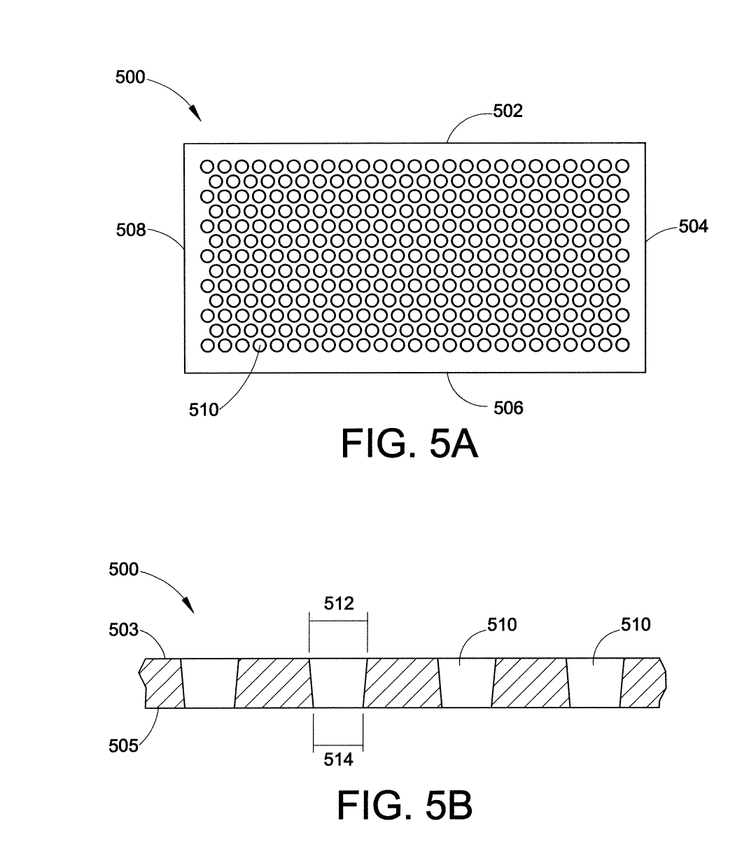

Referring now to FIG. 5A and FIG. 5B, the micropanel screen 500 is a sheet containing holes or perforations 510 extending from the upper side to the lower side. FIG. 5A is a top view showing the arrangement of the holes, while FIG. 5B is a cross-sectional view of the micropanel screen.

In FIG. 5A, the micropanel screen 500 is shown as a rectangle having four edges 502, 504, 506, 508. However, any desired shape may be used, such as circular, square, etc. The perforations 510 are shown as being arranged in offsetting rows. Any desired arrangement of the perforations may be used, though the arrangement should be able to meet any specified flow rate and/or pressure drop requirements necessary for the deep fryer with which the filter assembly is used. The perforations are also shown here as having a circular shape. However, any desired shape may be used, such as square, triangular, hexagonal, etc.

As seen in FIG. 5B, the micropanel screen 500 has a first or upper side 503, and a second or lower side 505. Each perforation 510 extends from the first side 503 to the second side 505. In particular, each perforation tapers from the first side down to the second side. Put, another way, perforation 510 has a first diameter 512 at the first side 503. When the perforation is not circular, the diameter should be considered the maximum width of the perforation. For example, in a square perforation, the diameter would be the diagonal. Perforation 510 also has a second diameter 514 at the second side 505. The first diameter 512 is greater than the second diameter 514. In embodiments, the first diameter may be from about 0.005 inches to about 0.010 inches. In other embodiments, the first diameter is about 0.002 inches greater than the second diameter. The perforations in the micropanel screen 500 can be made by processes known to those in the art, such as by etching, drilling, etc. The micropanel screen can generally remove particles having sizes of greater than 100 microns.

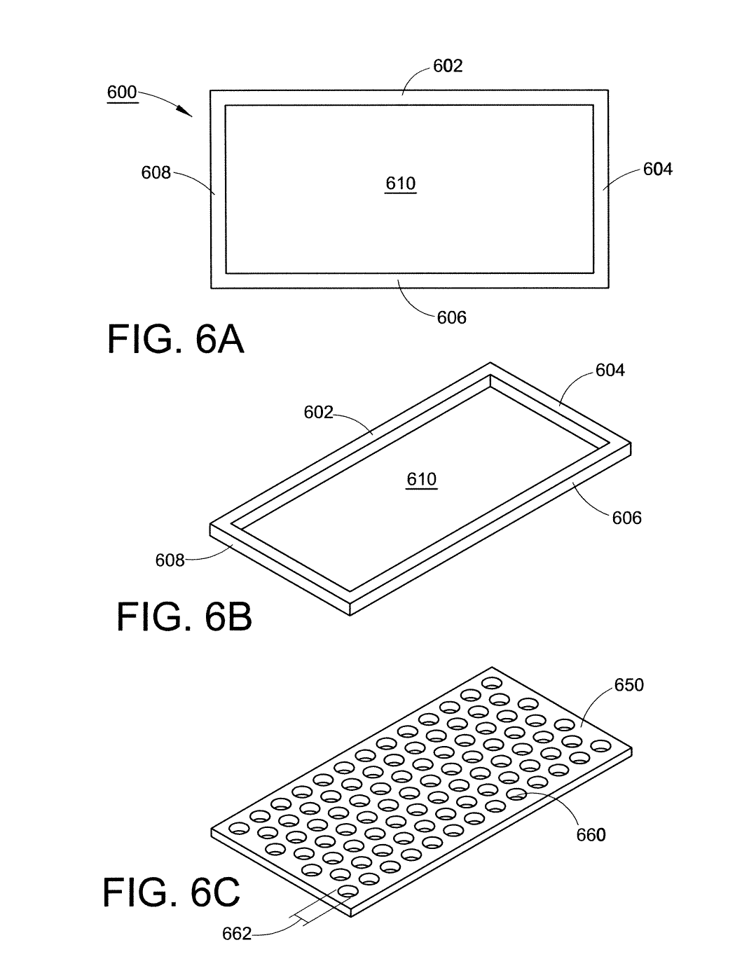

Referring now to FIGS. 6A-6C, it is contemplated that the support frame generally supports the micropanel screen along the perimeter of the micropanel screen. As a result, the support frame 600 is generally the same size and shape as the micropanel screen. For example, FIG. 6A is a top view of one embodiment of a support frame. Here, the support frame 600 is shown with four walls 602, 604, 606, 608, and would support the microscreen panel of FIG. 5A along edges 502, 504, 506, 508. The support frame also has at least one opening. FIG. 6B is a perspective view of the support frame of FIG. 6A, and shows the support frame with one central opening 620.

In the exemplary embodiment shown in FIG. 6C, the support frame 650 is a sheet having a plurality of cellular openings 660. The openings 660 are shown as being arranged in offsetting rows, and as having a circular shape. Again, any desired arrangement of the openings may be used. Also, any desired shape for the openings may be used, such as square, triangular, hexagonal, etc. However, it should be noted that the openings 660 in the support frame have a larger diameter than the perforations in the micropanel screen. This is because the function of the support frame is to support the micropanel screen, and larger openings in the support frame allow the oil to drain or pass through the filter assembly more quickly.

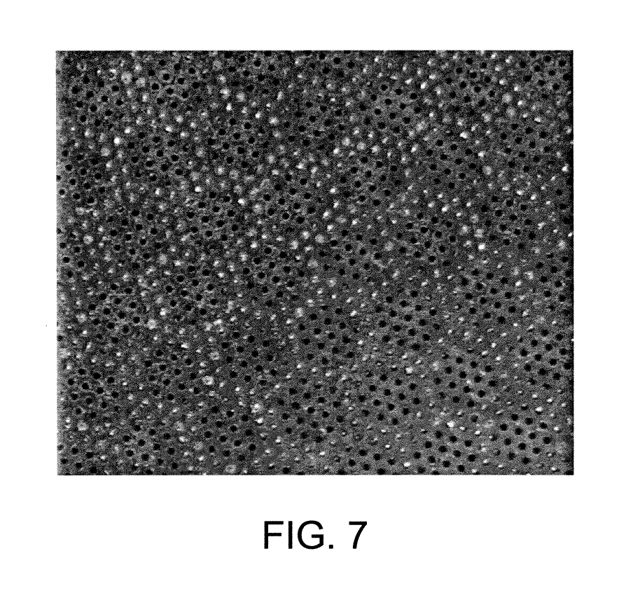

FIG. 7 is a top view picture showing a microscreen panel which has been brazed to a support frame similar to that of FIG. 6C. The microscreen panel is seen as small holes or openings. The support frame is seen as a series of honeycombs or cells having a hexagonal shape under the microscreen panel, and is made visible here by the brazing which has filled some of the holes/openings in the microscreen panel.

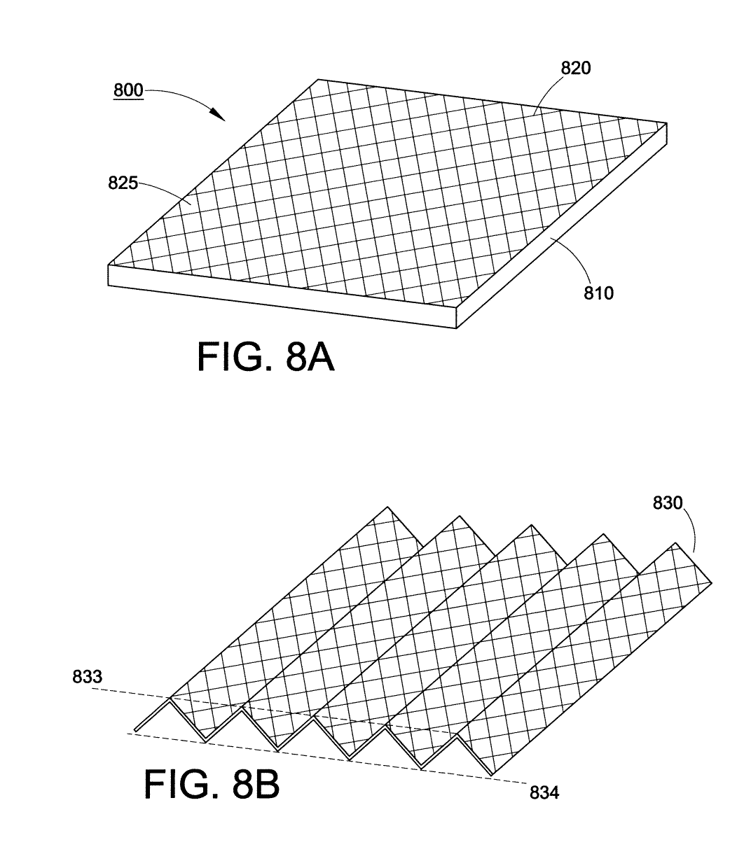

Referring now to FIG. 8A and FIG. 8B, a metal screen may be used with the microscreen panel, with the metal screen being used to filter relatively large particles before the cooking liquid passes through the microscreen panel. Generally, the metal screen includes a woven wire mesh. FIG. 8A shows a metal screen 800 with a frame 810 and a simple woven wire mesh 820. The wire mesh creates a series of pores 825, and the wire mesh is sized to generally capture particles greater than 10 microns in diameter. FIG. 8B shows a woven wire mesh 830 which has been pleated, i.e. the wire mesh has been folded back on itself and fixed in place. The pleating is seen as a zig-zag between an upper plane 832 and a lower plane 834. The pleated screen is particularly suited for catching particles larger than 50 microns in diameter. In particular embodiments, the metal screen is a pleated screen.

The weaving of the woven wire mesh may be of any suitable type. In particular embodiments, the woven wire mesh is a dutch twill woven wire mesh. The wire mesh is formed from two sets of wires, one set passing in a lateral direction (i.e. the warp wires) and the other set passing in a longitudinal direction (i.e. the shute wires). In dutch twill, the warp wires have a larger diameter than the shute wires. Each shute wire passes successively over two warp wires, and then under two warp wires. The shute wires are driven up close and deformed so that the mesh count is in excess of twice the sum of the wire count. The shute wires and warp wires can on the order of 0.001 inches in diameter and the finished woven wire screens can have a 10 micron pore size. In specific embodiments, the metal screen is a pleated double dutch twill woven wire mesh screen.

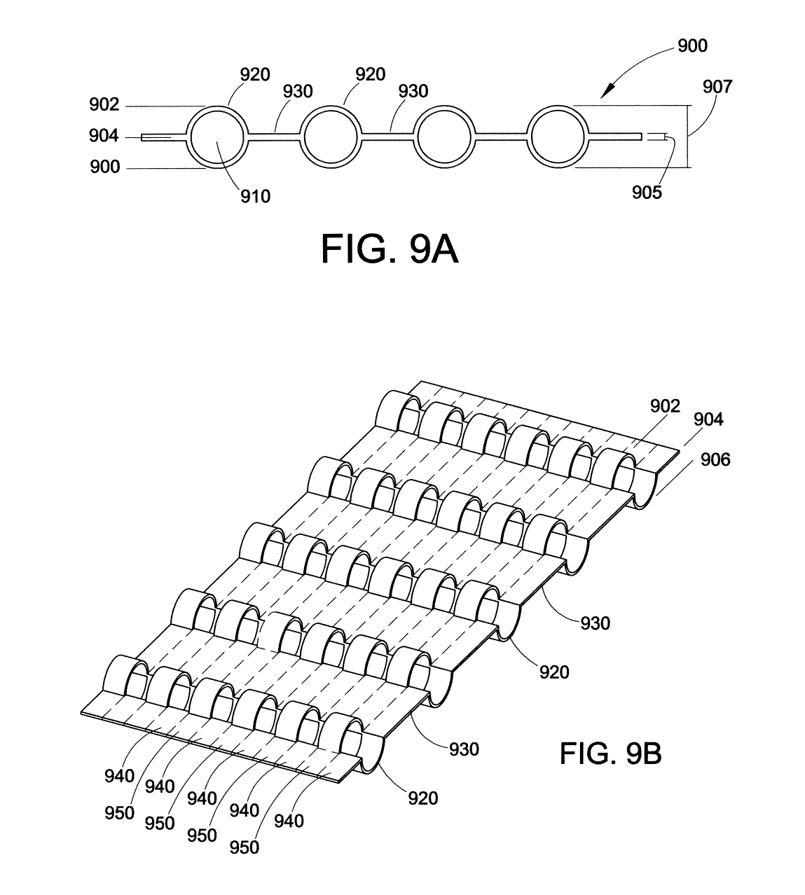

FIG. 9A and FIG. 9B illustrate a basket weave screen which can also be used as the metal screen in the filter assembly. FIG. 9A is a side view of a basket weave screen, and FIG. 9B is a perspective view of the basket weave screen. The basket weave screen is similar to a woven wire mesh in which the shute wires are subsequently removed. Referring to FIG. 9A, from the side, the basket weave screen 900 may be considered as having an upper plane 902, a base plane 904, and a lower plane 906. The screen begins in base plane 904 with a base thickness 905. At regular intervals 920, the screen extends in two different directions, towards upper plane 902 and lower plane 906. While the screen does not change its thickness, the height 907 of the screen may be considered as interval may be considered as extending from upper plane 902 to lower plane 906. A pore 910 is formed by this change in height of the screen. The screen then returns to the base plane 904 for regular intervals 930.

Referring to FIG. 9B, from a perspective view, the basket weave screen 900 may be considered to be formed from two different alternating rows 940, 950. Row 940 begins in base plane 904, forms an arch extending down to lower plane 906 in intervals 920, and returns to the base plane 904 for intervals 930. In contrast, row 950 begins in base plane 904, forms an arch extending up to upper plane 902 in intervals 920, and returns to the base plane 904 for intervals 930. This alternating up-and-down arrangement results in pores 910. Cooking liquid can flow sideways through the pores in order to travel through the basket weave screen 900, while large particles are trapped on the screen. In particular embodiments of the basket weave screen, each row 940, 950 has a width of about 0.215 inches and there are about 2.5 intervals 920 per inch.

In specific embodiments, the filter assembly comprises the micropanel screen and the support frame attached to one side of the micropanel screen. In other specific embodiments, the filter assembly comprises the micropanel screen and the support frame attached to one side of the micropanel screen, and the metal screen located on the other side of the micropanel screen. It is contemplated that the metal screen directly contacts the other side of the micropanel screen. In particular, there is no need for a disposable filter medium, i.e. cheese cloth or paper.

In other embodiments, the filter assembly comprises the metal screen, the micropanel screen, and the support frame. The support frame is brazed to a lower side or face of the micropanel screen, and the metal screen is brazed to an upper side or face of the micropanel screen.

The metal screen, micropanel screen, and the support frame are each generally made from a metal. Exemplary metals include stainless steel, particularly grade 304, i.e. 304SS; and grade 316.

The metal screen, micropanel screen, and the support frame may have any length and width needed to make a filter assembly of the size needed for any particular deep fryer. The metal screen, micropanel screen, and the support frame generally have the same length and width, although this may vary. The metal screen, used to filter relatively large particles, generally has a height of from about 0.5 to about 1 inch. The micropanel screen, used to filter relatively small particles, generally has a height of about 0.005 inches. The support frame generally has a height of from about 0.080 to about 1 inch.

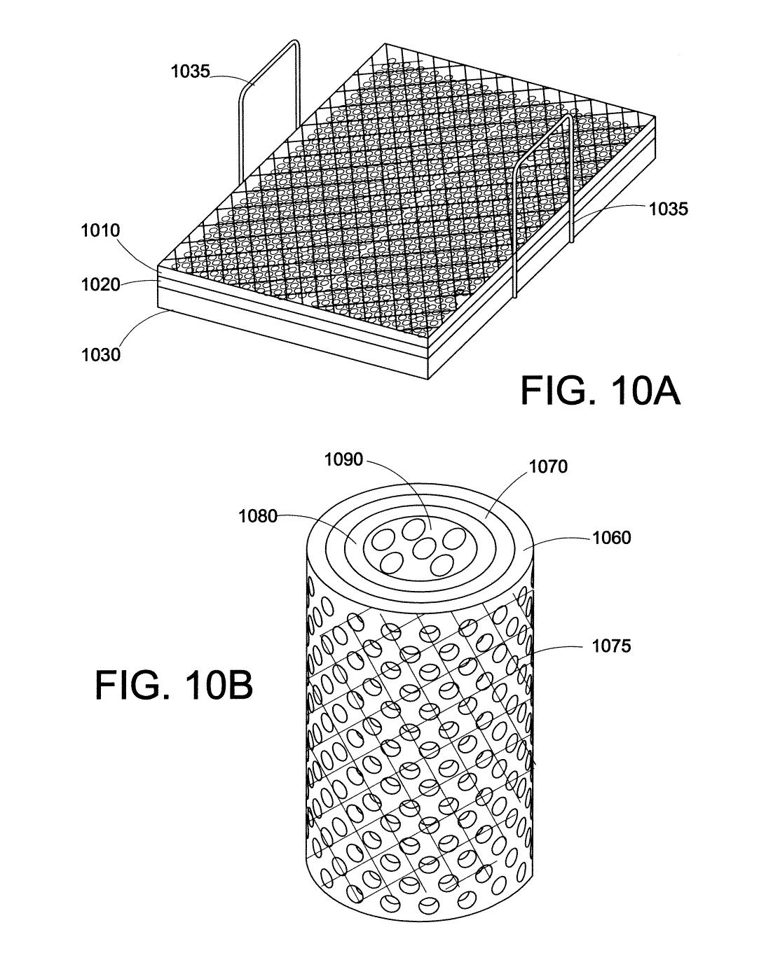

For example, in FIG. 10A, the filter assembly 1000 includes a metal screen 1010, micropanel screen 1020, and support frame 1030. The support frame includes two handles 1035 that extend upwards beyond the metal screen 1010. This embodiment might be suitable, for example, as a “drop-in” design that can be placed inside the fryer vat itself. When the cooking liquid is drained from the fryer vat, the cooking liquid passes through all of the layers of the filter assembly. The filter assembly can then be removed from the top of the fryer vat. Alternatively, the filter assembly itself is simply lifted upwards through the fryer vat, causing the cooking liquid to pass through all of the layers of the filter assembly.

Alternatively, in FIG. 10B, the filter assembly 1050 has a cylindrical shape. The metal screen 1060 is the outermost layer, followed by the micropanel screen 1070, and the support frame 1080 as the innermost layer, with an open core 1090. The perforations 1075 of the micropanel screen are visible through the metal screen 1060. This embodiment would be suitable for filtration systems that surround the filter assembly, with dirty cooking liquid passing from the outside through the filter assembly and filtered cooking liquid entering the core 1090.

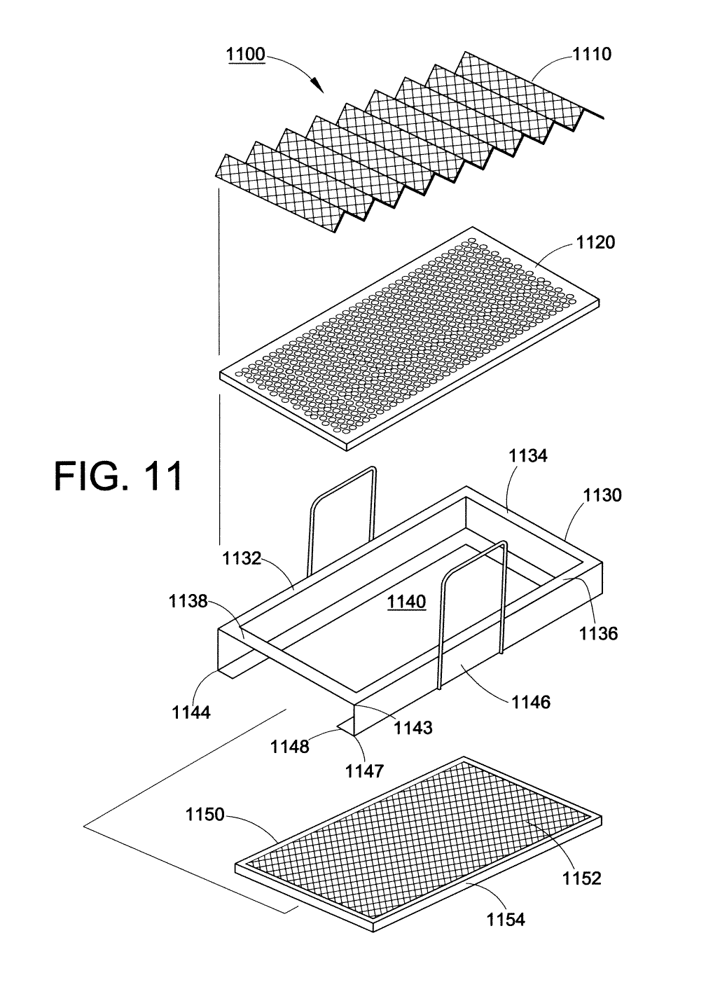

FIG. 11 is another alternative embodiment of the filter assembly. Here, the filter assembly 1100 has four different components. A pleated cloth screen 1110 is used as a top layer to filter out relatively large particles. A micropanel screen 1120 then filters out relatively small particles. The micropanel screen has an upper face and a lower face. A support frame 1130 is located below the micropanel screen 1120. The pleated cloth screen 1110, micropanel screen 1120, and support frame 1130 are brazed together. In this exemplary embodiment, the support frame is a windowed frame, having four sides 1132, 1134, 1136, 1138 and a large central opening 1140. The support frame 1130 also has an upper face 1143, to which the lower side of the micropanel screen 1120 is attached. The support frame is shaped to form a bracket 1144 on three sides of the frame 1130 below the upper face 1143. The bracket 1144 as be considered as being formed by a longitudinal sidewall 1146 extending downwards substantially perpendicularly from the upper face 1143 and a latitudinal sidewall 1148 extending inwards from the bottom edge 1147 of the longitudinal sidewall 1146. An optional additional filter 1150 can slide into the bracket 1144 to provide a final filtration step for the cooking liquid. It is contemplated that the additional filter 1150 will allow the user to choose the desired filtration level, for example a size of 5 microns or 20 microns. For example, a 5 micron size is a 200 by 1400 mesh size, while a 20 micron size is a 200 by 600 mesh size. In particular embodiments, the additional filter 1150 is a dutch twill woven wire mesh screen 1152 that is brazed to a window support frame 1154.

It should be noted that the filter assembly is intended to be used with the dirty cooking liquid first passing through the metal screen to remove the relatively large particles. The cooking liquid then passes through the micropanel screen to remove the relatively small particles. Thus, the terms “upper” and “lower” are relative to the filter assembly itself, not to an external reference point. For example, in the filtration system of FIG. 2, the metal screen would be closer to the cooking vessel 20 than the micropanel screen is. However, in the filtration system of FIG. 3, the micropanel screen would be closer to the cooking vessel 20 than the metal screen is.

In contrast to the three-layer filter assembly described in the present disclosure, a conventional filter assembly has four layers. First, a basket weave screen similar to that of FIG. 9B is used as the base. On top of the basket weave screen is placed a disposable filter medium, such as a paper filter. Next, a rod frame, like that shown in FIG. 6B, is placed over the edges of the disposable medium. Finally, a heavy weighted frame is placed over the rod frame to hold all of the other layers in place.

The filter assembly of the present disclosure compares favorably to the conventional filter assembly. The filter assembly of the present disclosure is made entirely of washable and reusable metal components. The filter assembly does not use any disposable filter medium. Rather, the filter assembly can be washed or rinsed off to remove the particulate matter trapped by the metal screen and the microscreen panel. It is contemplated that the optional metal screen and the microscreen panel are separable, so they can be separately washed. The present filter assembly also does not need a heavy weighted frame to hold down the paper filter medium. Because that weighted frame can be eliminated, the overall filter assembly is lighter, easier to handle, and less expensive. The filter assembly of the present disclosure will eliminate consumable filter paper, thus eliminating landfill waste as well.

The present disclosure has been described with reference to exemplary embodiments. Additional features, advantages, and embodiments of the present disclosure may be set forth or apparent from consideration of the detailed description, drawings, and claims. It is intended that the present disclosure be construed as including all such modifications and alterations insofar as they come within the scope of the appended claims or the equivalents thereof.

1. A filter assembly for filtering solid particles from a cooking liquid used in a deep fryer, comprising:
a micropanel screen for filtering relatively small particles, the micropanel screen having an upper side and a lower side;
a support frame attached to the lower side of the micropanel screen; and
a metal screen for filtering relatively large particles, the metal screen being located on the upper side of the micropanel screen.

2. The filter assembly of claim 1, wherein the metal screen is a pleated double dutch twill woven wire mesh screen.

3. The filter assembly of claim 1, wherein the metal screen is a basket weave screen.

4. The filter assembly of claim 1, wherein the support frame is brazed to the lower side of the micropanel screen.

5. The filter assembly of claim 4, wherein the support frame is nickel brazed to the lower side of the micropanel screen.

6. The filter assembly of claim 1, wherein the support frame further comprises at least one handle.

7. The filter assembly of claim 1, wherein the support frame is a windowed frame with four edges and a central opening.

8. The filter assembly of claim 1, wherein the support frame is a metal sheet with cellular openings.

9. The filter assembly of claim 1, wherein the micropanel screen has perforations that extend from the upper side and taper down to the lower side.

10. The filter assembly of claim 1, wherein the support frame includes openings, the openings of the support frame having a larger diameter than the perforations in the micropanel screen.

11. The filter assembly of claim 1, wherein the filter assembly does not include a disposable filter medium.

12. A filter assembly for a deep fryer, comprising:
a micropanel screen for filtering relatively small particles; and
a support frame attached to a lower side of the micropanel screen.

13. The filter assembly of claim 12, wherein the support frame is attached by brazing.

14. The filter assembly of claim 13, wherein the brazing is performed using nickel.

15. The filter assembly of claim 12, further comprising a metal screen located on a side of the micropanel screen opposite the support frame, the metal screen being useful for filtering relatively large particles.

16. The filter assembly of claim 12, wherein the micropanel screen has perforations that extend from an exposed side and taper down towards the lower side.

17. A process for filtering particles from a dirty cooking liquid, comprising:
passing the dirty cooking liquid through a metal screen to remove relatively large particles from the dirty cooking liquid to obtain a strained cooking liquid; and
passing the strained cooking liquid through a micropanel screen to remove relatively small particles from the strained cooking liquid to obtain a cleaned cooking liquid.

18. The process of claim 17, further comprising returning the cleaned cooking liquid to a cooking vessel from which the dirty cooking liquid was obtained.

19. The filter assembly of claim 1, wherein the support frame comprises an upper face attached to the lower side of the micropanel screen and a bracket extending downwards on three sides from the upper face; and further comprising an additional filter inserted into the bracket.

20. The filter assembly of claim 12, wherein the support frame comprises an upper face attached to the lower side of the micropanel screen and a bracket extending downwards on three sides from the upper face; and further comprising an additional filter inserted into the bracket.

21. A filter assembly for filtering solid particles from a cooking liquid used in a deep fryer, comprising:
a micropanel screen for filtering relatively small particles, the micropanel screen having an upper face and a lower face;
a metal screen for filtering relatively large particles, the metal screen being located on the upper face of the micropanel screen;
a support frame comprising an upper face, a bracket extending downwards on three sides from the upper face, and a central opening, wherein the upper face is attached to the lower face of the micropanel screen; and
an additional filter inserted into the bracket of the support frame.
